(19) United States
(12) Patent Application Publication
(10) Pub. No.: US 2014/0200774 A1
(43) Pub. Date: Jul. 17, 2014

(54) VEHICLE DOOR LATCH SYSTEM AND METHOD

(71) Applicant: GM GLOBAL TECHNOLOGY OPERATIONS LLC, Detroit, MI (US)

(72) Inventors: RICHARD J. LANGE, TROY, MI (US); FRANK J. ARABIA, JR., MACOMB, MI (US); ANDREAS HEBERER, Mainz (DE); JEFFREY L. KONCHAN, ROMEO, MI (US)

(73) Assignee: GM GLOBAL TECHNOLOGY OPERATIONS LLC, Detroit, MI (US)

(21) Appl. No.: 13/741,889

(22) Filed: Jan. 15, 2013

(51) Int. Cl. E05B 65/12

(52) U.S. Cl. CPC E05B 77/54
USPC 701/49

(57) ABSTRACT

A door latch system of a vehicle includes a fork bolt lever engagable with a striker and is movable between a latched position for securing the striker and an unlatched position. A detent is movable between an engaged position in which the detent engages with the fork bolt lever to hold the fork bolt lever in the latched position and a disengaged position in which the detent is disengaged from the fork bolt lever to permit the fork bolt lever to move to the unlatched position. A motor, controllable by the controller, is coupled to the detent lever to move the detent lever between the engaged and disengaged positions. A switch may send an unlatch command to the controller. The controller actuates the motor to position the detent in the disengaged position such that the detent is held in the disengaged position until a predetermined condition occurs.

### TECHNICAL FIELD

The technical field relates generally to door latch systems and methods for vehicles and specifically to electric door latch systems for automobiles.

### BACKGROUND

In an ongoing effort to reduce weight and mechanical complexity of automobiles, some manufacturers have turned to electric actuation of door latches. More specifically, some manufacturers have eliminated the traditional mechanical linkages between door handles and the door latch mechanism that enable the door to be opened. Instead, an electrical motor may control operation of the door latch mechanism.

However, several issues with such electric door latch systems may occur. For instance, if electric power is lost to the motor after an open command is sent but before the door is open, a conventional electric door latch system revert to a latched state, and thus potentially trapping the occupants of the vehicle.

As such, it is desirable to present a door latch system which allows ingress and egress of the vehicle even if power is interrupted. In addition, other desirable features and characteristics will become apparent from the subsequent summary and detailed description, and the appended claims, taken in conjunction with the accompanying drawings and this background.

### SUMMARY

A door latch system of a vehicle includes a striker disposed on one of a door or a frame of the vehicle and a fork bolt lever engagable with the striker and movable between a latched position for securing the striker and an unlatched position. A detent is movable between an engaged position in which the detent engages with the fork bolt lever to hold the fork bolt lever in the latched position and a disengaged position in which the detent is disengaged from the fork bolt lever to permit the fork bolt lever to move to the unlatched position. The system further includes a motor operatively connected to the detent lever to move the detent lever between the engaged and disengaged positions. A controller is in communication with the motor and configured to control operation of the motor. A switch is in communication with the controller and configured to send an unlatch command to the controller. The controller is configured to actuate the motor to position the detent in the disengaged position such that the detent is held in the disengaged position until a predetermined condition occurs.

A method of controlling the door latch system includes receiving an unlatch command at the controller from a switch operable by a user. The method also includes sending a command from the controller to the motor in response to receiving the unlatch command to position the detent in the disengaged position until a predetermined condition occurs.

### DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 illustrates a door latch system for a door of a vehicle according to one embodiment;

FIG. 2 is an exploded perspective view of a door latch mechanism according to one embodiment; and

FIG. 3 is a flowchart of a method of operating the door latch system according to one embodiment.

### DETAILED DESCRIPTION

Referring to the figures, wherein like numerals indicate like parts throughout the several views, a door latch system 10 of a vehicle (not shown), and methods of controlling a door latch, are shown and described herein. The vehicle described herein is an automobile (not shown). However, the door latch system 10 may be implemented on other types of vehicles.

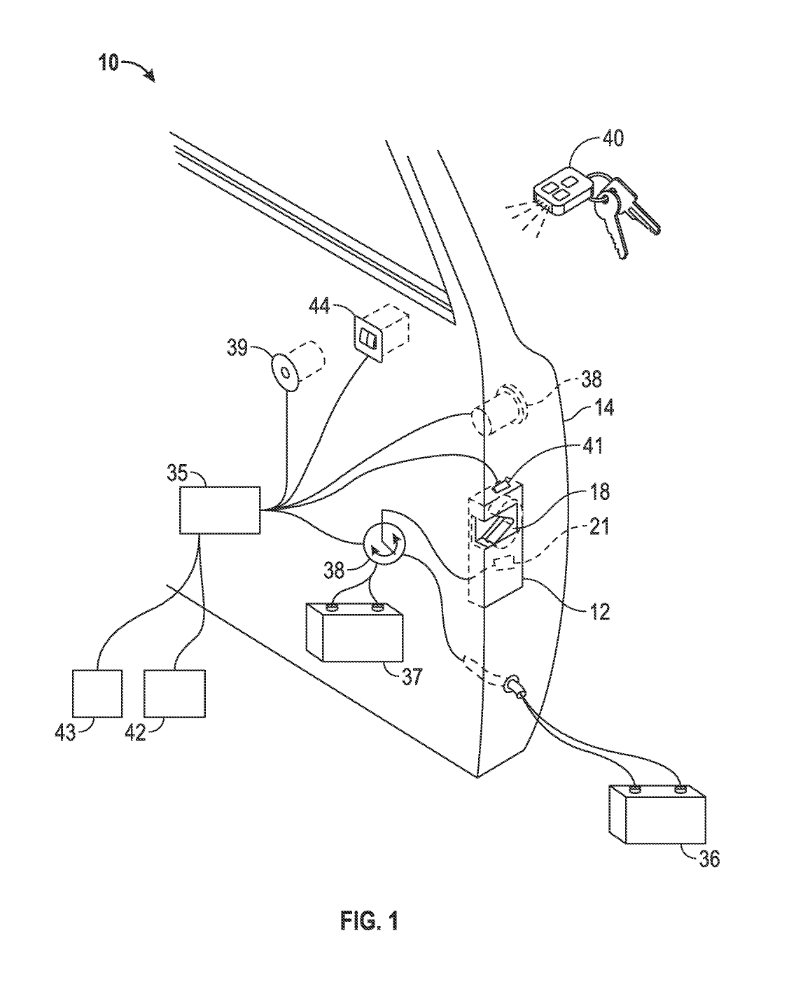

Referring to FIG. 1, the door latch system 10 of the illustrated embodiment includes a door latch mechanism 12 comprising the mechanical elements needed to latch a door 14 of the vehicle to a body (not shown) of the vehicle. These mechanical elements, and other parts, are discussed in detail in U.S. Pat. Nos. 4,756,563, 5,054,827, and 6,045,168, which are herein incorporated in their entirety by reference.

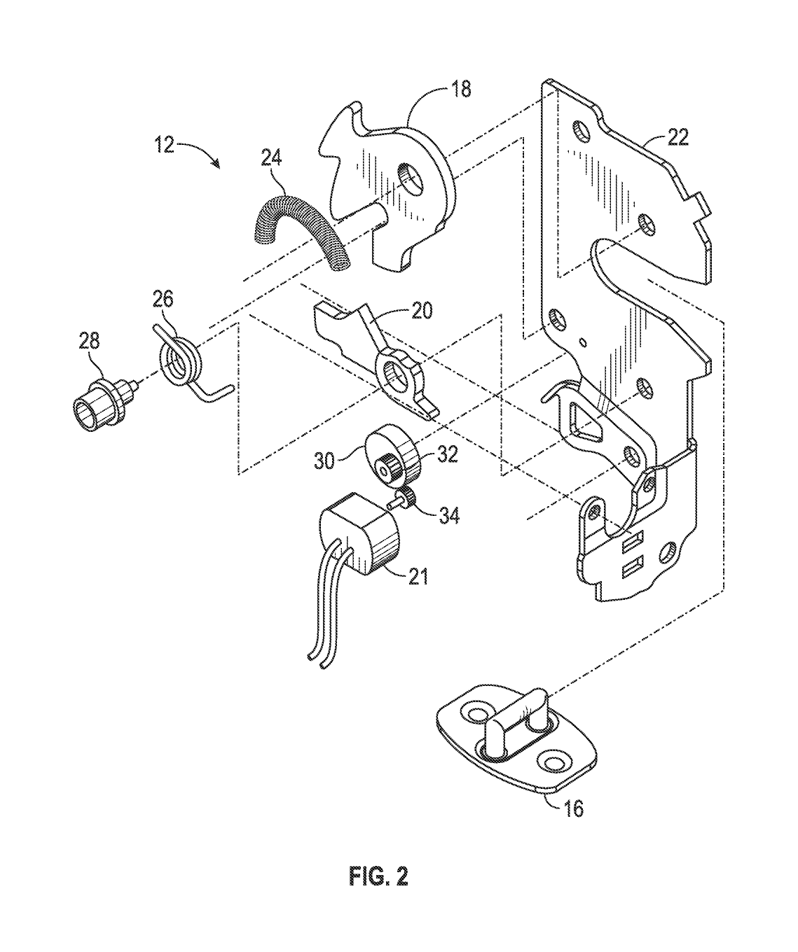

Referring now primarily to FIG. 2, the door latch mechanism 12 includes a striker 16. The striker 16 of the illustrated embodiment is disposed on the body of the vehicle. However, the striker 16 may alternatively be disposed on the door 14 while the door latch mechanism 12 is disposed on the body. The door latch mechanism 12 further includes a fork bolt lever 18. In the illustrated embodiment, the fork bolt lever 18 is disposed on the door 14. The fork bolt lever 18 is engagable with the striker 16. Furthermore, the fork bolt lever 18 is movable between a latched position for securing the striker 16 and an unlatched position. As realized by those skilled in the art, in the latched position, the door 14 is secured to the body, or frame, of the vehicle. Said simply, in the latched position, the door 14 is securely closed. In the unlatched position, the striker 16 is able to move away from the fork bolt lever 18 and as such, the door 14 is able to open.

The door latch mechanism 12 further includes a detent 20. The detent 20 is movable between an engaged position and a disengaged position. In the engaged position, the detent 20 engages the fork bolt lever 18 to hold the fork bolt lever 18 in the latched position. In the disengaged position, the detent 20 is disengaged from the fork bolt lever 18 to permit the fork bolt lever 18 to move to the unlatched position. A motor 21 is operatively connected to the detent 20 to move the detent 20 from the engaged position to the disengaged position. Furthermore, in the illustrated embodiment, an apparatus (not numbered) may be utilized to hold the detent 20 in the disengaged position once moved there by the motor 21.

Also in the illustrated embodiment, the detent 20 is disposed in a chamber (not shown) of a plastic housing (not shown) behind a metal face plate 22. An elongated coil spring 24 is disposed in a curved slot (not shown) in the plastic housing behind the fork bolt lever 18, and engages a depending pin (not numbered) of the fork bolt lever 18 at one end. The detent 20 is biased into engagement with the fork bolt lever 18 by a coil spring 26 that surrounds a bushing 28 that has one end engaging a housing (not shown) and one end engaging an ear (not numbered) of the detent 20. A cam 31 and gears 32, 34 may serve to couple the motor 21 to the detent 20. The cam 31 and gears 32, 34 may also be utilized as part of the apparatus to hold the detent 20 in the disengaged position. Of course, in other embodiments, other configurations may be utilized to implement the apparatus.

The detent 20 engages the fork bolt lever 18 in either an intermediate position or the latched position against the bias of coil spring 26 and the seal force of the door 14. The detent 20 continues to hold the fork bolt lever 18 in the intermediate or latched positions until the motor 21 moves the detent 20. When the motor 21 moves the detent 20 against the force of the coil spring 26 and the seal force of the door 22, the fork bolt lever 18 is then released. The coil spring 26 forces the fork bolt lever 18 back into the unlatched position, allowing the striker 16 to pull out of the fork bolt lever 18.

The door latch system 10 also includes a controller 35, as shown in FIG. 1. The controller 35 may comprise a computer, a processor, a microprocessor, an application specific integrated circuit (“ASIC”), digital logic gates, and/or another suitable device capable of receiving data and executing instructions in response to the received data. In FIG. 1, the controller 35 is shown disposed within the door 14. However, it is to be appreciated that the controller 35 may be disposed at other locations. Furthermore, the controller 35 of the door latch system 10 may be part of a vehicle control unit (not shown) which controls other aspects of the vehicle as well.

The controller 35 is in communication with the motor 21 and configured to control operation of the motor 21. Said another way, the controller 35 is configured to regulate when and if the motor 21 operates. Of course, electrical control elements (not shown) may be utilized to interface the controller 35 and the motor 21, as is readily appreciated by those skilled in the art and therefore not detailed herein. The controller 35 may also be configured to regulate the direction of operation of the motor 21 and/or the speed of operation of the motor 21. Further details regarding control of the motor 21 according to the illustrated embodiment are provided below.

The door latch system 10 further includes at least one power source 36, 37. The at least one power source 36, 37 is electrically connectable to the motor 21 for operating that motor 21. In the illustrated embodiment, a first power source 36 is disposed remote from the door 14 and the second power source 37 is disposed in and/or on the door 14. The first and second power sources 36, 37 of the illustrated embodiment are DC batteries, as are well known to those skilled in the art. However, other suitable power sources may alternatively be implemented. For instance, a capacitor may be utilized as one or both of the power sources 36, 37. Furthermore, the main DC battery of the vehicle may be implemented as one of the power sources 36, 37.

In the illustrated embodiment, a power switch 38 selectively connects either the first power source 36 or the second power source 37 to the motor 21. The power switch 38 and each of the power sources 36, 37 are in communication with the controller 28. The controller 28 analyzes the ability of each power source 36, 37 to provide electrical power to the motor 21 and adjusts the power switch 38 accordingly. A full description of the capabilities of utilizing multiple power sources 36, 37 with a door lock assembly may be found in U.S. Patent Application Publication No. 2010/0052337, which is hereby incorporated by reference.

The door latch system 10 further includes at least one switch 38, 39, 40 in communication with the controller 35. In the illustrated embodiment, as shown in FIG. 1, the system 10 includes a plurality of switches 38, 39, 40. Specifically, in the illustrated embodiment, each door 14 of the vehicle includes an exterior switch 38 positioned to be operated in an exterior (i.e., the outside) of the vehicle and an interior switch 39 positioned to be operated in an interior (i.e., the inside) of the vehicle. The interior and exterior switches 39, 38 may be integrated with handles (not shown) of the door 14 as is well known to those skilled the art. The door latch system 10 may also include a remote switch 40, e.g., a “key fob”.

A user of the vehicle presses the switch 38, 39, 40 when they want to open the door 14. As such, the switch 38, 39, 40 is configured to send an unlatch command to the controller 35. In the illustrated embodiment, the controller 35 then determines whether or not the door 14 should be opened, and consequently whether the detent 20 should be moved to the unlatched position, based on a locked or an unlocked status of the door 14. If permissible, i.e., if the door is “unlocked”, the controller 35 then sends a command to the motor 21 to operate the detent 20 which, in turn, allows the fork bolt lever 18 to move to the unlatched position, thus allowing the door 14 to be opened.

More specifically, the controller 35 is configured to actuate the motor 21 to position the detent 20 in the disengaged position. The detent 20 is then held in the disengaged position by the apparatus until a predetermined condition occurs. The controller 35 is also configured to actuate the motor 21 to position the detent 20 back to the engaged position in response to the predetermined condition occurring.

One possible predetermined condition is the door 14 being in an open position. As such, the system 10 of the illustrated embodiment includes a door position sensor 41 in communication with the controller 35 to sense the open position of the door 14 and send a door open signal to the controller 35. More specifically, in the illustrated embodiment, the door position sensor 41 senses the position of the fork bolt lever 18 as the fork bolt lever 18 does not move until the door 14 is pushed or pulled open.

By the detent 20 being held in the open position until the door 14 is in the open position, the door 14 may still be opened even in the event of a power interruption between the power sources 36, 37 and the motor 21. Such a power interruption could possibly occur during the partial or total submersion of the vehicle in water.

Another possible predetermined condition is the operating mode of the vehicle being other than a park mode, i.e., when the vehicle is taken out of “park”. Those skilled in the art appreciate that vehicle operating modes include at least one drive mode, a neutral mode, and the park mode. More specifically, the operating mode of the vehicle relates to the operating mode of a transmission 42 of the vehicle.

In the system 10 of the illustrated embodiment, the controller 35 is in communication with the transmission 42 of the vehicle. The controller 35 receives a transmission signal to indicate an operating mode of the transmission 42, and thus, an operating mode of the vehicle. Accordingly, the detent 20 is held in the open position until the vehicle is placed in an operating mode other than the park mode.

Yet another possible predetermined condition is the vehicle being “at speed”. The “at speed” condition may occur when the vehicle is moving normally, under its own power, at a predetermined speed. As such, the vehicle may include a speed sensor 43 in communication with the controller 35. The speed sensor 43 provides a speed signal corresponding to a travel speed of the vehicle.

As stated above, the system 10 allows the door to be opened upon one of the switches 38, 39, 40 being actuated. However, by only holding the detent 20 in the disengaged position until either the vehicle is no longer in the park mode or the vehicle begins moving, the system 10 allows for the detent 20 to revert to the engaged position once the vehicle begins to move.

This may be important in situations where the door 14 cannot be opened due to a freezing condition. For example, as described above, the detent 20 is moved to the unlatched position upon one of the switches 38, 39, 40 being pressed. However, despite being unlatched and being mechanically able to open, if frozen to the frame, the door 14 will not open. As such, an undesired condition (e.g., the door 14 unexpectedly opening) could occur should the door unfreeze while the detent 20 is in the unlatched position. Accordingly, by only holding the detent 20 in the unlatched position until the vehicle is no longer in the park mode and/or the vehicle begins moving, the fork bolt lever 18 may move to the latched position before the vehicle reaches a high speed.

A further possible predetermined condition is the elapse of a predetermined time period. In the illustrated embodiment, the predetermined time period is at least ten seconds. More specifically, the predetermined time period is 15 seconds. However, those skilled in the art will appreciate other suitable time periods.

Furthermore, in the illustrated embodiment, the elapse of the predetermined time period is one of the possible predetermined condition only when the exterior switch 38 or the remote switch 40 is utilized to send the unlatch command to the controller 35. In other words, the elapse of the predetermined time period is not one of the possible predetermined conditions if the interior switch 39 is utilized to send the unlatch command to the controller 35. As such, the system 10 will still provide security to the vehicle in the event of an unsuccessful attempt to open the door 14 which is frozen shut.

The system 10 may further include at least one door lock/unlock button 44 in communication with the controller 35. The door lock/unlock button 44 allows a user to send a lock command or an unlock command to the controller 35. The lock and unlock commands may be applicable to a specific door 14 or all of the doors 14 of the vehicle as is appreciated by those skilled in the art. The controller 35 is configured prevent the motor 21 moving the detent to the disengaged position if the lock command has been sent to the controller 35 for the door 14. Said plainly, the above descriptions of actuating the motor to move the detent to the disengaged position may not be applicable when the door 14 is in a locked state.

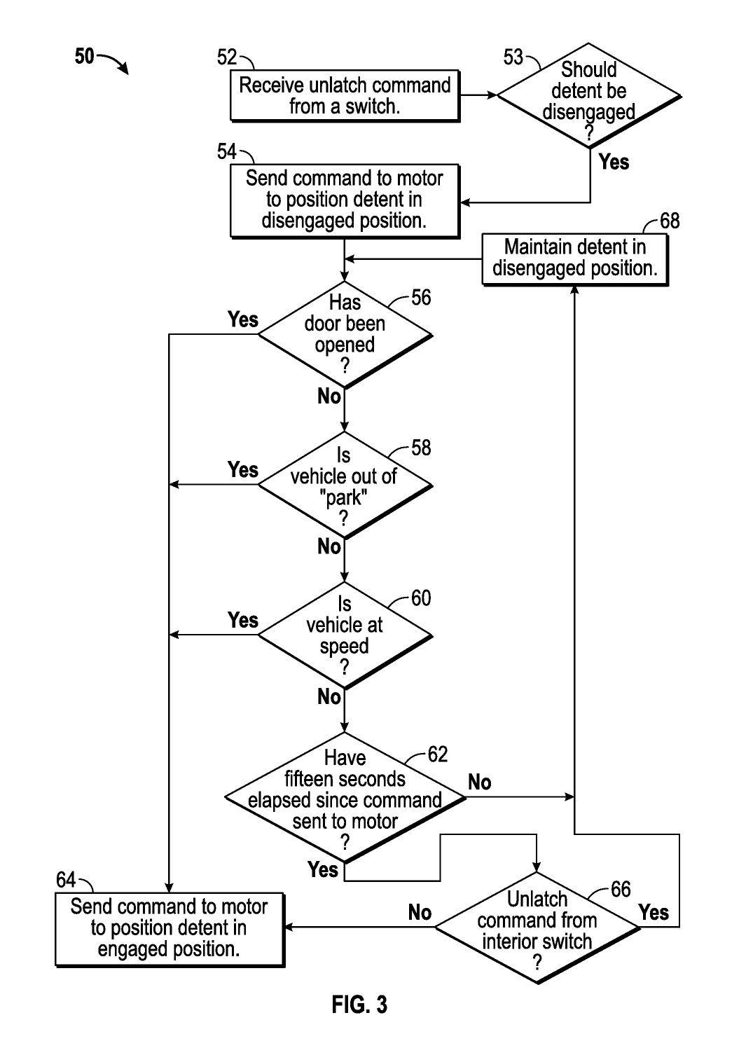

Although the system 10 described above details a method of controlling the door latch system, FIG. 3 illustrates one exemplary method 50. The method 50 includes the step 52 of receiving an unlatch command from the switch 38, 39, 40. In response to receiving the unlatch command, the method 50 includes the step 53 of determining if the detent 18 should be disengaged. For example, if the door 14 is in the locked state, the detent 20 will not be disengaged.

If the detent is permitted to be disengaged, the method then includes the step 54 of sending the command to the motor 21 to position the detent 18 in the disengaged position. In response to step 54 being initiated, the method 50 of this illustrated embodiment continues with a plurality of decision steps 56, 58, 60, 62.

In a first decision step 56, the controller 35 determines if the door 14 has been opened. If the door 14 has been opened, then the method 50 proceeds with the step 64 of sending a command to the motor 21 to position the detent 18 in the engaged position. If the door 14 has not been opened, the method 50 continues to a second decision step 58.

In the second decision step 58, the controller 35 determines if the vehicle is out of the park mode. If the vehicle is no longer in park, then the method 50 proceeds with step 64 of sending a command to the motor 21 to position the detent 18 in the engaged position. If the vehicle is still in park, then the method 50 continues to a third decision step 60.

In the third decision step 60, the controller 35 determines if the vehicle is at speed. If the vehicle is at speed, then the method 50 proceeds with step 64. If the vehicle is not at speed, then the method 50 continues to a fourth decision step 62.

In the fourth decision step 62, the controller 35 determines if 15 seconds have elapsed since the commands of step 54 have been executed. If 15 seconds have elapsed, then, in a fifth decision step 66, the controller 35 determines whether the unlatch command was sent from the interior switch 33. If the unlatch command was not sent from the interior switch 33, then the method proceeds with step 64 of sending a command to the motor 21 to position the detent 18 in the engaged position. If 15 seconds have not elapsed or if the unlatch command was sent from an exterior switch 32, 34, then the method 50 proceeds with the step 68 of maintaining the detent 18 in the disengaged position.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

1. A door latch system of a vehicle, comprising:
a striker disposed on one of a door or a frame of the vehicle;
a fork bolt lever engageable with said striker and movable between a latched position for securing said striker and an unlatched position;
a detent movable between an engaged position in which said detent engages with said fork bolt lever to hold said fork bolt lever in said latched position and a disengaged position in which said detent is disengaged from said fork bolt lever to permit said fork bolt lever to move to said unlatched position;
a motor operatively connected to said detent to move said detent between said engaged and disengaged positions;
a controller in communication with said motor and configured to control operation of said motor; and
a switch in communication with said controller and configured to send an unlatch command to said controller;
wherein said controller is configured to actuate said motor to position said detent in said disengaged position such that said detent is held in said disengaged position until a predetermined condition occurs.

2. A system as set forth in claim 1 wherein said controller is further configured to actuate said motor to position said detent in said engaged position in response to an occurrence of the predetermined condition.

3. A system as set forth in claim 1 further comprising at least one power source electrically connectable to said motor for operating said motor.

4. A system as set forth in claim 1 wherein said controller is in communication with a door position sensor and said sensor is configured to sense an open position of the door and send a door open signal to said controller.

5. A system as set forth in claim 4 wherein the predetermined condition comprises the door being positioned in an open position.

6. A system as set forth in claim 4 wherein said door position sensor senses the position of said fork bolt lever.

7. A system as set forth in claim 1 wherein said controller is in communication with a transmission of the vehicle and said controller receives a transmission signal to indicate an operating mode of the transmission.

8. A system as set forth in claim 7 wherein the predetermined condition comprises the transmission being in an operating mode other than park.

9. A system as set forth in claim 1 wherein said controller is in communication with a speed sensor providing a speed signal corresponding to a travel speed of the vehicle.

10. A system as set forth in claim 1 wherein said switch is further defined as an interior switch positioned to be operated in an interior of the vehicle.

11. A system as set forth in claim 1 wherein said switch is further defined as an exterior switch positioned to be operated in an exterior of the vehicle.

12. A system as set forth in claim 11 wherein the predetermined condition comprises an elapse of a predetermined time period.

13. A system as set forth in claim 11 wherein the predetermined time period is at least 10 seconds.

14. A method of controlling a door latch system of a vehicle, the door latch system including a striker disposed on one of a door or a frame of the vehicle, a fork bolt lever engageable with the striker and movable between a latched position and an unlatched position, a detent movable between an engaged position in which the detent engages the fork bolt lever to hold the fork bolt lever in the latched position and a disengaged position in which the detent is disengaged from the fork bolt lever to permit the fork bolt lever to move to the unlatched position, a motor operatively connected to the detent to move the detent, and a controller in communication with the motor, said method comprising:
receiving an unlatch command at the controller from a switch operable by a user of the vehicle; and
sending a command from the controller to the motor in response to receiving the unlatch command to position the detent in the disengaged position and hold the detent the disengaged position until a predetermined condition occurs.

15. A method as set forth in claim 14 further comprising sending a command from the controller to the motor to position the detent in the engaged position in response to an occurrence of the predetermined condition.

16. A method as set forth in claim 14 further comprising receiving a door open signal at the controller and wherein the predetermined condition comprises the receipt of the door open signal.

17. A method as set forth in claim 14 further comprising receiving a transmission signal indicating an operating mode of the transmission at the controller and wherein the predetermined condition comprises the operating mode of the transmission being other than a park mode.

18. A method as set forth in claim 14 further comprising receiving a speed signal corresponding to a travel speed of the vehicle and wherein the predetermined condition comprises the travel speed of the vehicle being greater than or equal to a predetermined speed.

19. A method as set forth in claim 14 wherein the predetermined condition comprises an elapse of a predetermined time period.

20. A method as set forth in claim 19 wherein the predetermined time period is at least 10 seconds.

1. A door latch system of a vehicle, comprising:
a striker disposed on one of a door or a frame of the vehicle;
a fork bolt lever engageable with said striker and movable between a latched position for securing said striker and an unlatched position;
a detent movable between an engaged position in which said detent engages with said fork bolt lever to hold said fork bolt lever in said latched position and a disengaged position in which said detent is disengaged from said fork bolt lever to permit said fork bolt lever to move to said unlatched position;
a motor operatively connected to said detent to move said detent between said engaged and disengaged positions;
a controller in communication with said motor and configured to control operation of said motor; and
a switch in communication with said controller and configured to send an unlatch command to said controller;
wherein said controller is configured to actuate said motor to position said detent in said disengaged position such that said detent is held in said disengaged position until a predetermined condition occurs.

2. A system as set forth in claim 1 wherein said controller is further configured to actuate said motor to position said detent in said engaged position in response to an occurrence of the predetermined condition.

3. A system as set forth in claim 1 further comprising at least one power source electrically connectable to said motor for operating said motor.

4. A system as set forth in claim 1 wherein said controller is in communication with a door position sensor and said sensor is configured to sense an open position of the door and send a door open signal to said controller.

5. A system as set forth in claim 4 wherein the predetermined condition comprises the door being positioned in an open position.

6. A system as set forth in claim 4 wherein said door position sensor senses the position of said fork bolt lever.

7. A system as set forth in claim 1 wherein said controller is in communication with a transmission of the vehicle and said controller receives a transmission signal to indicate an operating mode of the transmission.

8. A system as set forth in claim 7 wherein the predetermined condition comprises the transmission being in an operating mode other than park.

9. A system as set forth in claim 1 wherein said controller is in communication with a speed sensor providing a speed signal corresponding to a travel speed of the vehicle.

10. A system as set forth in claim 1 wherein said switch is further defined as an interior switch positioned to be operated in an interior of the vehicle.

11. A system as set forth in claim 1 wherein said switch is further defined as an exterior switch positioned to be operated in an exterior of the vehicle.

12. A system as set forth in claim 11 wherein the predetermined condition comprises an elapse of a predetermined time period.

13. A system as set forth in claim 11 wherein the predetermined time period is at least 10 seconds.

14. A method of controlling a door latch system of a vehicle, the door latch system including a striker disposed on one of a door or a frame of the vehicle, a fork bolt lever engageable with the striker and movable between a latched position and an unlatched position, a detent movable between an engaged position in which the detent engages the fork bolt lever to hold the fork bolt lever in the latched position and a disengaged position in which the detent is disengaged from the fork bolt lever to permit the fork bolt lever to move to the unlatched position, a motor operatively connected to the detent to move the detent, and a controller in communication with the motor, said method comprising:
receiving an unlatch command at the controller from a switch operable by a user of the vehicle; and
sending a command from the controller to the motor in response to receiving the unlatch command to position the detent in the disengaged position and hold the detent the disengaged position until a predetermined condition occurs.

15. A method as set forth in claim 14 further comprising sending a command from the controller to the motor to position the detent in the engaged position in response to an occurrence of the predetermined condition.

16. A method as set forth in claim 14 further comprising receiving a door open signal at the controller and wherein the predetermined condition comprises the receipt of the door open signal.

17. A method as set forth in claim 14 further comprising receiving a transmission signal indicating an operating mode of the transmission at the controller and wherein the predetermined condition comprises the operating mode of the transmission being other than a park mode.

18. A method as set forth in claim 14 further comprising receiving a speed signal corresponding to a travel speed of the vehicle and wherein the predetermined condition comprises the travel speed of the vehicle being greater than or equal to a predetermined speed.

19. A method as set forth in claim 14 wherein the predetermined condition comprises an elapse of a predetermined time period.

20. A method as set forth in claim 19 wherein the predetermined time period is at least 10 seconds.
